(19) United States
(12) Patent Application Publication
(10) Pub. No.: US 2013/0002839 A1
(43) Pub. Date: Jan. 3, 2013

(54) Device and Method for the Recognition of Glasses for Stereoscopic Vision, and Related Method to Control the Display of a Stereoscopic Video Stream

(75) Inventors: Dario Pennisi, Fiumicino (IT); Antonio Caramelli, Roma (IT)

(73) Assignee: 3DSWITCH S.R.L., Roma (IT)

(21) Appl. No.: 13/520,698

(22) PCT Filed: Jan. 7, 2011
(86) PCT No.: PCT/IB11/50060

§ 371 Date: Jul. 31, 2012

(30) Foreign Application Priority Data
Jan. 7, 2010 (IT) TO2010A000003

(51) Int. Cl. H04N 13/04

(52) U.S. Cl. 348/58; 348/54; 348/E13.026

(57) ABSTRACT

A method for the recognition of stereoscopic glasses, wherein two images of an environment in front of a screen are acquired from the same point of view. A differential image is then calculated by subtracting one of the two images from the other one, and the presence of two lenses is detected within the differential image. A method is also provided for controlling the display of stereoscopic images by using the method for the recognition of glasses. Also described are the devices allowing the methods to be implemented.

The present invention relates in general to stereoscopic display systems. The invention particularly relates to a method for the recognition of glasses for stereoscopic vision according to the preamble of claim 1, as well as to a display system which uses such a method in order to control the display of a stereoscopic image or video stream.

As known, stereoscopic vision is obtained by using two images relating to corresponding perspectives of a same object, typically a right perspective and a left perspective.

The images relating to these two perspectives (typically referred to as right image and left image) are intended for the right eye and the left eye, respectively, so that the human brain will integrate together both perspectives into one image perceived as being three-dimensional.

The right and left images can be obtained by using a suitable acquisition system (a so-called “stereoscopic camera” with two objectives or a pair of cameras), or else by starting from a first image (e.g. the left image) and then building the other image (e.g. the right image) electronically (by numerical processing).

Many techniques have been developed so far which allow the fruition of 3D contents transmitted through stereoscopic images.

A first known technique alternates over time the visualisation of the right image with the visualisation of the left image.

This technique however suffers from the drawback that the user must wear active glasses (also known as “shutter glasses”), which alternately shade the right eye or the left eye, so that each eye can only see the images associated with a given perspective.

According to another known technique, the right and left images are projected by means of differently polarized light. This may be obtained, for example, by appropriately treating a screen of a television set or by using suitable filters in a projector.

In this case as well, the user must wear suitable glasses (passive ones in this case) fitted with differently polarized lenses, each allowing only either the right or the left image to pass.

In both cases, if the user tries to watch a video stream without wearing these special glasses (hereafter referred to as stereoscopic glasses to distinguish them from normal prescription glasses), the vision will be disturbed and blurred, resulting in the user's eyes getting tired, which may lead to a headache.

For this reason, systems for displaying 3D videos and images exist which allow the user to manually select either monoscopic vision (2D) or stereoscopic vision (3D). Thus, if the user wants to watch 3D contents, then he/she will put on the stereoscopic glasses and select the 3D display mode; otherwise, he/she will select the 2D display mode and will not have to wear the stereoscopic glasses.

On the other hand, the manual adjustment by the user limits the flexibility of use of the stereoscopic device, since it may happen that the user has difficulty in switching the video signal display mode, e.g. because of physical handicaps, or due to the position of the display device, or because the latter is complex to use.

To solve this problem, some known stereoscopic vision systems are automatically controlled.

For example, patents JP2001326949A and JP2008171013A describe devices which allow the user to carry out other activities while he/she is wearing active glasses for stereoscopic vision. These systems use a camera installed on the glasses which, when pointed at the screen, recognizes it and outputs a signal to the control unit of the glasses, which are then activated. When the user is not watching the screen, the glasses are deactivated, i.e. neither eye is shaded.

These devices have the drawback that they require powered stereoscopic glasses fitted with a camera, which are complex, heavy and expensive.

In addition, the solution proposed by these patents requires the user to always wear the glasses, since the video signal is always displayed in stereoscopic mode. Therefore, these solutions do not provide a solution to the problem of how to display a video signal when the user is not wearing stereoscopic glasses.

Patent JP1093987A describes a device capable of automatically switching itself between monoscopic and stereoscopic vision based on the signal received from a sensor arranged on the screen, which detects the radiation emitted by an infrared source on the stereoscopic glasses; the video signal is thus displayed in stereoscopic mode only when the user who is wearing the stereoscopic glasses is facing the screen. This device has the drawback that the glasses require a specific power supply for the infrared source, and are therefore both complex and expensive.

The object of the present invention is to provide a device and a method which solve the problems of the prior art.

In particular, it is an object of the present invention to provide a method that allows to recognise the presence of stereoscopic glasses in an environment in front of a screen which is displaying 3D contents, e.g. where a stereoscopic video stream is being projected or displayed.

It is also an object of the present invention to provide a method which allows to detect the presence of the glasses without requiring any changes, or at least no bulky and/or costly changes, to the stereoscopic glasses themselves.

It is another object of the present invention to provide a method and an associated device which allow to effectively control a stereoscopic content display device.

It is a further object of the present invention to provide a method and an associated device which allow to control the display mode of a video stream depending on the analysis of the environment in front of the screen on which stereoscopic images are being displayed.

It is yet another object of the present invention to provide a method for controlling the display of a stereoscopic video stream in a manner as close as possible to the intentions of the people sitting in front of the screen where the stereoscopic video contents are being displayed.

These and other objects of the present invention are achieved through a device and a method incorporating the features set out in the appended claims, which are intended as an integral part of the present description.

The general idea at the basis of the present invention is to provide a method for the recognition of stereoscopic glasses, wherein at least two images of an environment in front of the projected image are acquired from the same point of view, so as to frame one or more users. By exploiting the properties of stereoscopic glasses (lens polarization or alternate eye shading), the presence of these glasses is recognized by means of a comparison between the two images.

The method described herein is implemented through a device comprising at least one sensor that acquires images and means for appropriately processing said images.

This solution overcomes the drawbacks of the prior art in that the glasses are detected without requiring the use of cameras or other active elements (e.g. light sources) installed on the glasses to detect their presence.

Such a detection also improves the flexibility of use of the stereoscopic display system, because it allows one display mode to be automatically selected depending on whether or not the stereoscopic glasses are present in the environment framed by the sensor. For example, the method allows for automatically switching between monoscopic vision and stereoscopic vision. Moreover, in those systems where the image pair is generated locally, the method allows the depth of the stereoscopic image to be adjusted in accordance with the conditions detected by the sensor.

By using different image acquisition modes (e.g. at preset time intervals or through polarized light), the idea proposed herein allows for the detection of both polarized-lens glasses (with circular or linear polarization) and active glasses (e.g. “shutter glasses”). It is therefore apparent that the solution disclosed herein offers significant advantages in terms of flexibility of use.

Also advantageously, the glasses detection method can detect whether the glasses are being worn or not, e.g. by comparing the position of the people's faces with the position of the glasses. The display mode which is most likely desired by the user can thus be selected more accurately.

For example, if the glasses are on the table, this means that the user wants to watch the video in monoscopic mode (2D), and hence that display mode will be selected; vice versa, if the glasses are being worn, then it is clear that the user wants to watch a 3D video; in this case, the stereoscopic display mode will be selected.

In a further advantageous embodiment, the method can detect if all the users are wearing glasses for stereoscopic vision. Thus, if only some of the users are wearing stereoscopic glasses, then a display mode (e.g. 2D) will be selected which will not disturb too much the sight of those not wearing such glasses, and/or suitable messages will be shown to the audience. In one embodiment, for example, if the input signal is stereoscopic and nobody is wearing glasses, then a message will be generated to suggest the use of glasses and the signal will be displayed in 2D format; if only some spectators are wearing glasses, then a similar message will be generated to suggest to those not wearing glasses to put them on. The messages thus generated may be visual and/or acoustic, and may utilise OSD (On Screen Display) techniques for displaying characters or graphic symbols superimposed on the video, or they may make use of luminous signals such as lights going on and off outside the screen. Further objects and advantages of the present invention will become more apparent from the following detailed description of a few preferred embodiments thereof, wherein reference will be made to the annexed drawings, which are supplied by way of non-limiting example, wherein:

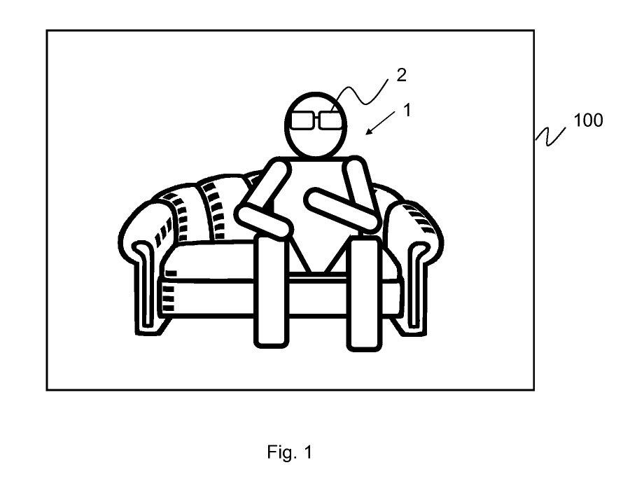

FIG. 1 is a schematic image of an example of a scene taken by the device according to the present invention.

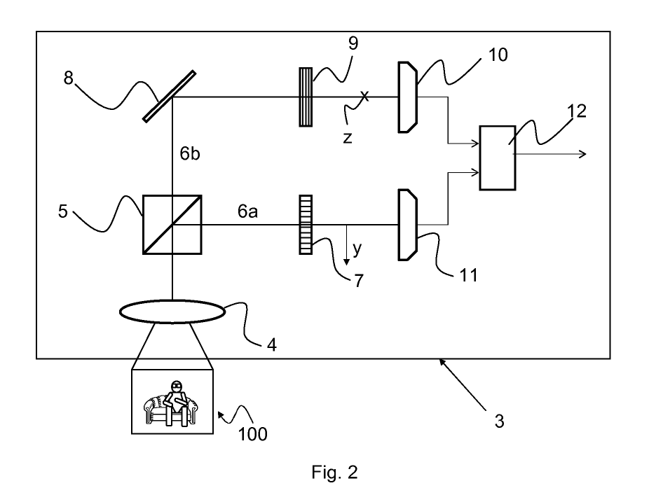

FIG. 2 shows a first embodiment of the device according to the present invention.

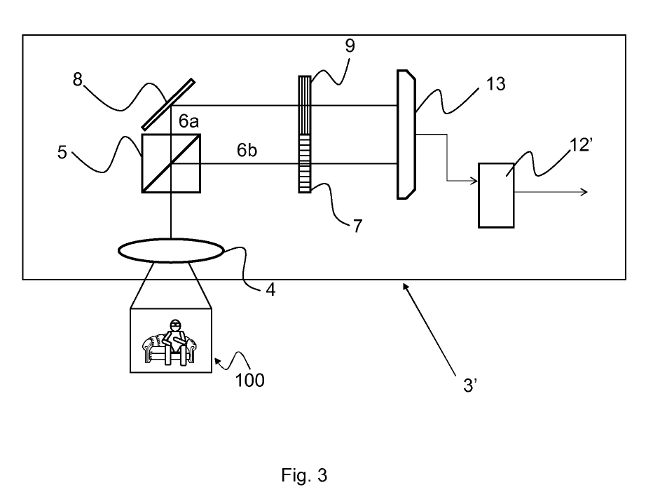

FIG. 3 shows a second embodiment of the device according to the present invention.

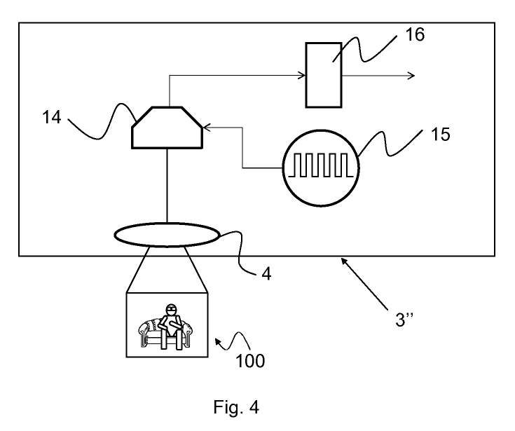

FIG. 4 shows a third embodiment of the device according to the present invention.

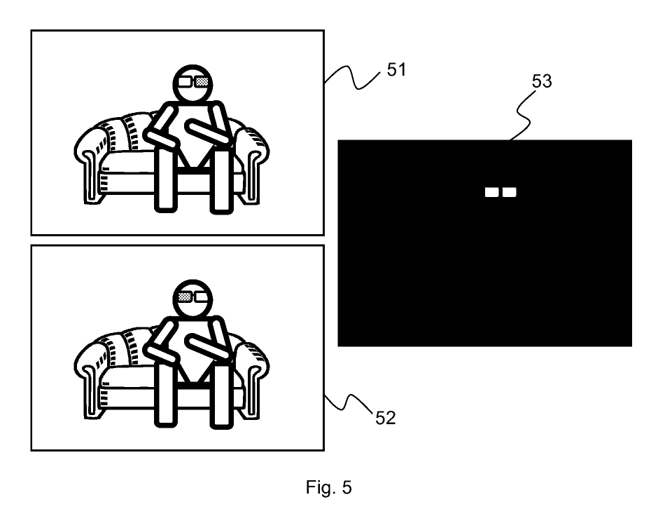

FIG. 5 shows a first embodiment of the method according to the present invention.

The example of FIG. 1 shows an image 100 representing the scene typically found in front of a screen, i.e. a user 1 sitting on a sofa. The user 1 is wearing stereoscopic glasses 2 in order to watch stereoscopic contents (images or videos).

The image 100 of FIG. 1 is an image of the environment in front of a screen where stereoscopic contents are being displayed, e.g. a screen of a television set or a sheet on which an image is being projected.

The image 100 is acquired by a camera device located near the screen and facing the user 1 sitting in front of the screen. Thus, the camera device will frontally shoot the environment before the screen. This shooting perspective is preferred because the stereoscopic glasses possibly worn by the user are framed frontally, and therefore the lens area seen by the camera device is larger than if the environment were shot laterally.

Alternatively, the camera device may be placed in different positions, even far from the screen, but nonetheless it should preferably frame an environment in front of the latter.

In both cases it is preferable and advantageous to provide the camera device with suitable infrared light sources illuminating the environment, in order to improve the further processing of the environment image according to the method described below. FIG. 2 schematically shows a first embodiment of the camera device 3 which acquires the image 100.

The device 3 comprises an objective lens 4 which frames the scene of the image 100, as previously described with reference to FIG. 1.

The framed image 100 is then transmitted to a beam splitter 5, which creates two separate optical paths. The images following the first optical path 6a are filtered by a first polarizer 7, so that the radiation emitted by the polarizer is polarized in a first direction, e.g. a horizontal direction orthogonal to the direction of propagation, or else according to a circular polarization, e.g. counterclockwise. The images following the second optical path 6b after being outputted by the beam splitter 5 are reflected by the mirror 8 and are filtered by a second polarizer 9 which can polarize the incoming radiation in a second direction of polarization, different from (and preferably orthogonal to) said first direction of polarization, or else according to a circular polarization opposite to the previous one, i.e. clockwise. In the example of FIG. 2, the luminous radiation outputted by the polarizer 9 is polarized vertically (direction z in FIG. 2).

The device further comprises two image sensors 10 and 11, each detecting one of the images arriving along the two different optical paths 6a e 6b. The two sensors may be, for example, CCD sensors or sensors using any other technology suitable for the purpose of detecting light, or in general a luminous radiation, in particular visible or infrared radiation.

By so doing, two images are obtained which have been captured from the same point of view and at the same time instant, one of which has been filtered by a first polarizer 7, whereas the other one has been filtered by a second polarizer 9.

The images acquired by the image sensors 10 and 11 are then transformed into electric signals and transmitted to the means 12, which will process them in accordance with the method that will be described later on. Said means 12 preferably consist of a processor or a microcontroller, but they may comprise one or more connected, integrated or interconnected electronic devices capable of comparing the images received from the image sensors 10 and 11 according to the following procedure.

The device 3 allows to detect the presence of glasses for stereoscopic vision using polarized-lens technology. To this end, the polarizer filters 7 and 9 allow to polarize the light in the two directions of polarization of the right and left images being displayed by the television set or projector and being watched by the user. The polarizer filters will therefore have the same polarization capacities as the two lenses of the glasses 2.

In an alternative embodiment, in order to acquire two polarized images of the same environment, the camera device is equipped with a light source, e.g. of the infrared type, which illuminates the scene by means of polarized light in the two directions of polarization of the images. This is obtained, for example, through two infrared LEDs arranged behind two polarizer filters of the same type as the lenses of the stereoscopic glasses. As an alternative, it is conceivable to employ a mechanical system capable of moving two polarizer filters having a non-polarized light source, so as to obtain an alternation of polarized light in two different modes determined by the two filters. Such a system may, for example, comprise a wheel with two filters covering half the wheel area; when the wheel is turned, the light emitted by the non-polarized source is alternately polarized by the two filters. In this embodiment, the camera device may be equipped with a beam splitter as in FIG. 2, so as to acquire images of the environment at the same time instant, but with different polarization. Alternatively, the camera device may be simplified and use a single image sensor and no beam splitter. In such a case, the two LEDs which illuminate the environment, are controlled alternately, and two images are acquired which are taken at two different time instants. By rapidly alternating (by a few tens or hundreds of ms) the illumination of the environment, the two images can be compared for the purpose of detecting the stereoscopic glasses, as will be further explained below. This alternative embodiment, wherein the scene is illuminated with polarized light according to two different polarizations, is applicable to the case of passive glasses; in such a case the polarizers along the optical path(s) within the device are not needed. In this embodiment, special care must be taken to avoid reflections onto foreign bodies (i.e. bodies other than stereoscopic glasses, like sofa, tables, vases, floor), which might affect light polarization and result in a disturbed detection of the lenses in the scene.

The example of FIG. 3 shows a further embodiment of the camera device. The same items as those shown in FIG. 2 are designated by the same numerals.

In this embodiment, the camera device 3′ only includes a single image sensor. The light taken by the objective 4 is split into two optical paths 6a and 6b by the beam splitter 5; subsequently, the polarizers 7 and 9 arranged along the two optical paths polarize the incoming radiation and output two polarized images which converge in the two halves of the image sensor 13, the output of which is then transmitted to the means 12′ adapted to process it.

This variant privileges the compactness of the device and allows to reduce the number of components thereof.

FIG. 4 shows another embodiment of the camera device. The camera device 3″ comprises an objective lens 4 which frames the scene previously described with reference to FIG. 1. The input image is directly transmitted to an image sensor 14, which acquires images at a frequency set by the synchronisation means 15. The image acquisition frequency corresponds to the stereoscopic image display frequency or a whole multiple thereof, e.g. 50 Hz, so that one image is acquired every fiftieth of a second. Preferably, the synchronisation means 15 are built in or connected to the television set or projector displaying the images or video stream being watched by the user 1, so that the images are acquired synchronously with the visualisation of the right and left images.

The images acquired by the image sensor 14 are transmitted to the means 16, which then process them in accordance with the method that will be described later on.

This device 3″ is particularly suited whenever the presence of “shutter” active glasses for stereoscopic vision is to be detected. In fact, at the various acquisition instants the device can detect the differences in the opening and/or shutting degree of each lens of the glasses 2.

If the synchronisation means 15 are synchronised with the visualisation of the right and left images, they will also be synchronised with the “shutter” glasses, which, as known, are synchronised with the television set or projector, so that the right eye will always see the right image and the left eye will always see the left image. In this way, the device 3″ always frames one shut (closed) lens and one transparent (open) lens, but in two consecutive frames the lens which is shut in the first frame will be open in the second frame, and vice versa.

Therefore, in different images successively taken by the device at different time instants, a lens which is shut in the first image taken will be open in the second image, whereas the opposite will occur for the other lens of the glasses.

In one embodiment, the camera device 3″ comprises a light source, e.g. of the infrared type, which illuminates the scene through light pulsing at the same frequency as that of image acquisition. Alternatively, the scene may be illuminated by means of light pulsing at a frequency being a whole submultiple of the image acquisition frequency, or anyway equal to the device's shooting frequency. Said light source is therefore preferably controlled by the synchronisation means 15.

In a further embodiment, the camera device 3″ comprises a light source, e.g. of the infrared type, which illuminates the scene by staying always on, i.e. without time pulses.

In this embodiment, the light source is preferably activated in a selective way when the illumination conditions are considered to be unfavourable by suitable means of the device 3″. If, on the contrary, the natural illumination of the scene is sufficient, then the light source will stay off. Thus, this embodiment combines construction simplicity (the light source is not pulsed) with low energy consumption (the light source is only turned on when necessary).

In all of the above-described embodiments, the camera device allows to implement a method for detecting stereoscopic glasses and for controlling stereoscopic vision.

FIG. 5 shows the various steps of a first embodiment of said method, which for clarity will be described with reference to the camera device 3.

The device 3 acquires the images 51 and 52, corresponding to the two images filtered by the polarizers 7 and 9. FIG. 5 highlights the difference between the left lens and the right lens of the polarized stereoscopic glasses being worn by the user. In the image 51 the left lens is dark, whereas in the image 52 the same lens is transparent. This is because when the light passes through a polarizer filter, the lens with the same polarization will be transparent, while the other one will be dark due to its different polarization.

The same types of images 51 and 52 will be obtained if the glasses are active ones (e.g. “shutter glasses”) and the images are acquired at different time instants, as previously explained in the description of the device 3″ of FIG. 4.

In both cases, following the acquisition of the two images 51 and 52, the method for the recognition of the presence of stereoscopic glasses provides for comparing said images in order to detect the differences between them.

In one embodiment, the image 51 is subtracted from the image 52 (of course, the opposite could be done as well, i.e. the image 52 might be subtracted from the image 51).

As known, an image is made up of a plurality of pixels whose RGB values are represented by a sequence of bits; hence, subtracting two images is equivalent to subtracting the RGB values of a pixel of an image from those of a corresponding pixel of the other image.

The result of this difference is an image whose pixels have an almost null value everywhere, with the exception of the areas occupied by the lenses of the stereoscopic glasses. In these areas there will be positive and negative values, respectively, corresponding to the two lenses, as shown in the image 53, whereas the remaining part of the image 53 will be completely null (shown in black herein).

In the example of the differential image 53, the portion of the image not occupied by the lenses is completely null because the images 51 and 52 are perfectly identical.

It is clear that, in real cases, the images subtracted from each other may slightly differ even in the areas not occupied by the lenses, due to noise or other disturbance. It is obvious that, in this case, the portion of the differential image where the RGB values of the pixels are close to zero will be considered to be virtually null, while the areas occupied by the lenses in the differential image will have higher RGB values above a predetermined threshold value.

It must be pointed out that in the case wherein the two images are taken at different time instants (as is the case, for example, of the shutter glasses previously described with reference to FIG. 4), the two images cannot be perfectly superimposed because of possible spectator motion. However, in the next step which will be described below, the glasses pattern will still be recognized because it is extremely unlikely that motion-induced differences can reproduce a pattern similar to that produced by the glasses. In one embodiment, in order to avoid situations where spectator motion might compromise the measurement, the method provides for estimating a confidence index based on a sum of the squares of the differences between corresponding pixels in the two acquired images, so as to understand to what extent the two images differ from each other. Such an index may, for example, be the mean value of the differences of a portion or all of the pixels of the two images, or the number of differences exceeding a certain predetermined threshold value.

If the confidence index exceeds a predefined value (e.g. calculated empirically), the measurement will be ignored and the signal indicating the presence of the glasses will not be generated until the confidence index returns below the threshold, which means that the motion of the lenses of the glasses worn by the spectator in the scene has substantially ceased.

In yet another embodiment, in order to avoid situations where spectator motion might compromise the measurement, the method provides, as an alternative o in addition to the above, for detecting the motion of the user by means of known motion detection techniques, i.e. object tracking techniques. In this manner, it is possible to detect the motion of the user's face or of the lenses detected within the image. The translation of the lenses in the subsequent images can thus be estimated, correlating it with the presence of the glasses in the framed scene.

Referring back to the method for the recognition of glasses, after calculating the differential image the method performs a step of recognising the glasses within the differential image.

In one embodiment, the glasses are detected by detecting the presence of two lenses within the differential image. In one embodiment, a lens is detected when there is a group of contiguous non-null pixels in a number exceeding a predetermined value. In another embodiment, a lens is detected by comparing a group of contiguous non-null pixels with predefined lens images.

In one embodiment, the pattern in the areas occupied by the lenses is recognized by means of pattern research or image processing techniques like, for example, Haar's technical note. This method can be implemented, for example, by using per se known software libraries such as the OpenCV (“Open Computer Vision”) library, which contains several implementations of artificial vision algorithms.

For the purpose of recognising the lenses within the differential image, it is advantageous to take into account appropriate tolerances in the lens shape by evaluating the accuracy of the method for the various scene shooting conditions which may occur during the vision of stereoscopic images (e.g., scene poorly illuminated, presence of grazing light on the glasses, etc.).

In the absence of glasses, the two images 51 and 52 would be substantially identical; hence, the differential image 53 would be completely null and the processor of the camera device (e.g. the means 12, 12′ or 16) would detect the absence of glasses.

If there are two sensors, or if the optics of the camera device are not perfectly aligned, the two acquired images cannot be immediately superimposed. Aiming at improving the detection of glasses, the method includes an initial calibration step to ensure the best alignment and linearity of the images.

In a preferred embodiment, after having recognized the presence (or absence) of stereoscopic glasses, the camera device outputs a signal representative of the presence or absence of the glasses.

With reference to FIGS. 2, 3 and 4, such a signal is indicated by the arrow departing from the means 12, 12′ and 16, which are responsible for its generation. In one embodiment, the device for the recognition of stereoscopic glasses is a device independent of the display system (television set, set-top-box, projector, etc.), and comprises transmission means (not shown in FIGS. 2 to 4) which allow the signal indicating the presence of stereoscopic glasses to be transmitted to the display system. The transmission of the signal from the glasses recognition device may take place through wired or wireless means, by using either standardised communication modes and protocols (USB, Bluetooth, Wi-Fi, Ethernet, etc.) or proprietary protocols. The display system is therefore provided with means for receiving and decoding such a signal, as well as means adapted to control the display of 3D contents based on the received signal, as described below.

Of course, the glasses recognition device may be integrated into the display system; in such a case, the same means used for detecting the presence of the glasses may also control the visualisation of the 3D image; for example, said signal may be used for switching from monoscopic vision to stereoscopic vision (or vice versa).

Thus, by using the glasses detection system in accordance with the above-described method, it is possible to implement a method for controlling the display of images and/or video streams, wherein the display mode which is most suited to the user's desire is selected automatically by displaying stereoscopic images only when the user is wearing stereoscopic glasses. This improves the flexibility of use of the stereoscopic image display apparatus.

In a further embodiment, in addition to detecting the presence of glasses as previously described (i.e. comparing two images shot with different polarized light or at different predetermined time instants), the method also detects the presence of people's heads within the image. More preferably, the method can detect the presence of faces.

This face detection is obtained by means of per se known facial recognition techniques, commonly used in the security and video surveillance fields.

Preferably, faces are only detected on one of the two acquired images, so as to reduce the processing time and the computational cost of the detection process.

The method preferably provides for detecting the area occupied by the faces.

The face recognition and glasses recognition steps may be carried out in parallel or in any order.

The position of the faces in the image is then compared with the position of the lenses.

From the comparison between the position of the faces and the position of the lenses, it is detected if the stereoscopic glasses are being worn by a user or are simply lying on a piece of furniture or a sofa in such a position as to be framed by the device. This step of the method may preferably also be implemented by means of OpenCV algorithms.

In a further embodiment, the method provides for detecting if the number of detected glasses (possibly calculated based on the number of detected lenses) corresponds to the number of detected faces, more preferably if all the glasses are being worn (i.e. if all the glasses are within the areas of the recognized faces).

If all the users are wearing glasses, then the display control method will display the video stream in a stereoscopic mode.

If, on the contrary, it is recognized that a user is not wearing stereoscopic glasses, then the method will change the display mode, e.g. by switching to a monoscopic mode. Alternatively, it is conceivable that the method will change the display mode to another stereoscopic mode with a reduced depth in order to mitigate the discomfort felt by the spectator without stereoscopic glasses.

In one embodiment, in addition or as an alternative to the selection of the display mode depending on whether all users are wearing glasses or not, the method also provides for generating information messages for the audience.

For example, if the input signal is a stereoscopic one and nobody is wearing glasses, then a (visual and/acoustic) message will be generated to suggest the use of glasses and the signal will be displayed in 2D format. If only some of the spectators are wearing glasses, then a message will be generated to suggest to those spectators without glasses to put them on. The messages thus generated may be visual and/or acoustic, and may utilise OSD (On Screen Display) techniques for displaying characters or graphic symbols superimposed on the video, or they may make use of luminous signals such as lights going on and off outside the screen. The method described so far may additionally comprise an adaptive training step, useful for more effectively recognising those situations in which the user wants the display mode to be switched automatically, e.g. by defining the preferred shape of the pattern to be associated with the stereoscopic glasses. Stereoscopic glasses may, for example, differ from one another in shape and dimensions, but all must have some common features (e.g. polarization type or activation frequency) which allow them to be recognized by the camera device. Preferably, this adaptive training may also be implemented by means of OpenCV algorithms.

In the event that the camera device frames glasses having polarized lenses but unsuitable for stereoscopic vision (e.g. special sunglasses), the method will recognise the presence of such glasses because the difference between the two images will highlight the presence of lenses with the same polarization, and therefore the method will assume that there are no stereoscopic glasses in that position.

The acquisition and processing of the images by the above-described device may take place continuously or, more preferably, may be repeated at regular time intervals, e.g. every 15 seconds. By increasing the length of the intervals it is possible, for example, to reduce the computational load of the device.

In one embodiment, the images of the environment in front of the screen are acquired and processed continuously, meaning by this that the acquisition and processing steps are continuously repeated; of course, since such a process takes some time (a few ms), the term “continuous acquisition and processing” means that said process is continually repeated. In this embodiment, the display mode is not continually changed at each glasses presence detection; this avoids that any false detections may cause the image to be continually switched between two different display modes. In one embodiment, the signal useful for the selection of the video stream display mode is generated after a predetermined number of acquisition and processing steps have been completed: in other words, a certain number of acquisitions are necessary for the display mode to change; one acquisition is not enough. Alternatively, the signal is continuously generated at the end of each processing step, but the display device will ignore it.

It is apparent that many changes may be made to the present invention by those skilled in the art without departing from the protection scope thereof as stated in the appended claims. In particular, it is clear that the invention is not limited to the single embodiments described herein, since other embodiments are conceivable by combining together items and features of different embodiments among those described (and possibly also with technical solutions per se known to the man skilled in the art) into different methods and devices still using the basic idea of recognising stereoscopic glasses by acquiring and comparing two images taken from the same point of view, or anyway of controlling the display mode of a video stream thanks to such a glasses detection process.

It is also apparent that the invention is not limited to the camera device for detecting the presence of stereoscopic glasses, but may be extended to a video display system comprising both said camera device and means adapted to receive a stereoscopic video stream, as well as means adapted to display said stereoscopic video stream in accordance with a method for controlling the display mode of a video stream as described above. In such a system, the camera device and the display device (e.g. a television set or a projector) may be connected or integrated together or otherwise operationally associated with each other.

In one variant, the method for the recognition of stereoscopic glasses proposed herein may comprise algorithms for detecting the glasses pattern motion in order to provide additional functionalities such as, for example, switching the video signal or even modifying the stereoscopic images to avoid parallax effects in stereoscopic systems generating in real time the images for either one of the two eyes.

In a further embodiment, “shutter” glasses are fitted with two polarized filters preferably arranged near the two lenses, e.g. outside the frame, beside the lenses. This allows to use a device which can detect the presence of polarized stereoscopic glasses even if the latter are of the shutter type. When the device is shooting the environment in front of the screen with polarized light in the two directions of the two filters, the latter will appear respectively transparent or dark as previously explained with reference to FIG. 5, and will thus allow the glasses to be detected by means of the above-described method. The advantage of this method is that it prevents any detection uncertainty or errors from occurring due to spectator motion.

1. A method for the recognition of stereoscopic glasses, wherein two images (51, 52) of an environment in front of a screen adapted to display stereoscopic video streams are acquired from the same point of view, characterised in that:
a differential image (53) is calculated by subtracting one of said two images (51, 52) from the other one, and
the presence of two lenses of stereoscopic glasses (2) is detected within said differential image (53).

2. A method according to claim 1, wherein a lens is detected when there is a group of contiguous non-null pixels in a number exceeding a predetermined value.

3. A method according to claim 1, wherein a lens is detected by comparing a group of contiguous non-null pixels with predefined lens images.

4. A method according to claim 1, wherein said two images (51, 52) are acquired through a respective polarizer filter (7, 9), wherein the polarizer filters (7, 9) associated with said two images are different and have the same polarization capacities as said lenses.

5. A method according to claim 1, wherein said two images (51, 52) are acquired at different time instants, and wherein the acquisition of said images (51, 52) is synchronised with the visualisation of a right image and a left image on said screen.

6. A method according to claim 5, wherein said right and left images correspond to two different stereoscopic frames of a stereoscopic video stream.

7. A method according to claim 1, wherein several detections of said glasses take place over time, wherein during a first detection the shape and/or size of said detected glasses are stored in a memory, and wherein during a subsequent detection the shape and/or size of the detected glasses are compared with the stored shape and/or size.

8. A method according to claim 1, wherein several detections of said glasses take place over time, and wherein the display mode is only changed after the image acquisition and glasses detection steps have been repeated for a predetermined number of times.

9. A method for controlling the display mode of a stereoscopic video stream, wherein said stereoscopic video stream comprises a sequence of right images intended for a user's right eye and a sequence of left images intended for a user's left eye, the method being characterised in that
the presence of stereoscopic glasses within an environment in front of a screen adapted to display stereoscopic video streams is detected through a method incorporating the features set out in claim 1, and that
said stereoscopic stream is displayed in a mode that depends on the detection of said stereoscopic glasses.

10. A method according to claim 9, wherein the detection of the stereoscopic glasses is repeated over time and the display mode is automatically switched when the result of said detection changes.

11. A method according to claim 9, wherein said video stream is displayed in stereoscopic mode when said glasses are detected, and wherein said video stream is displayed in monoscopic mode when said glasses are not detected.

12. A method according to claim 9, further comprising a step of recognising users' faces within said environment in front of the screen, so as to display said video stream as a function of the detection of said glasses and of the detection of said faces in a position corresponding to that of the glasses.

13. A method according to claim 12, wherein acoustic and/or visual messages are generated if all the detected glasses are in a position corresponding to a face.

14. A device for the recognition of glasses for stereoscopic vision, comprising at least one sensor (10,11,13,14) for acquiring images and means (12,12′) for processing said acquired images, characterised in that said processing means (12,12′) are adapted to implement a method for the recognition of glasses according to claim 1.

15. A device according to claim 14, further comprising
a beam splitter (5) adapted to split the light acquired by a lens into two different optical paths,
a first polarizer (7) placed on a first one of said two optical paths and adapted to polarize the incoming light with a first type of polarization, and
a second polarizer (9) placed on a second one of said two optical paths and adapted to polarize the incoming light with a second type of polarization.

16. A device according to claim 15, wherein said first image and said second image are acquired each by a respective image sensor (10,11).

17. A device according to claim 15, wherein said first image and said second image are both acquired by a single image sensor (14).

18. A device according to claim 14, further comprising means for illuminating the scene framed by said at least one image sensor.

19. A device according to claim 18, wherein said illumination means comprise a source of polarized light.

20. A device according to claim 19, wherein said device comprises a source of non-polarized light, in particular infrared light, and a mechanical system adapted to move a pair of polarizer filters in front of said source of non-polarized light.

21. A device according to claim 14, further comprising means adapted to output to said device a signal relating to the detection of said glasses.

22. A video display system, comprising:
a device for detecting the presence of stereoscopic glasses according to claim 14,
means for receiving a stereoscopic video stream, and
means adapted to display said stereoscopic video stream according to a method wherein said stereoscopic video stream comprises a sequence of right images intended for a user's right eye and a sequence of left images intended for a user's left eye, the method being characterised in that:
the presence of stereoscopic glasses within an environment in front of a screen adapted to display stereoscopic video streams is detected through a method wherein two images (51, 52) of an environment in front of a screen adapted to display stereoscopic video streams are acquired from the same point of view, characterised in that:
a differential image (53) is calculated by subtracting one of said two images (51, 52) from the other one, and
the presence of two lenses of stereoscopic glasses (2) is detected within said differential image (53), and that
said stereoscopic stream is displayed in a mode that depends on the detection of said stereoscopic glasses.
